(19) United States
(12) Patent Application Publication
(10) Pub. No.: US 2006/0057501 A1
(43) Pub. Date: Mar. 16, 2006

(54) Antireflective compositions for photoresists

(76) Inventors: Hengpeng Wu, Hillsborough, NJ (US); Shuji Ding-Lee, Branchburg, NJ (US); Zhong Xiang, Somerset, NJ (US); Aritaka Hishida, Bedminster, NJ (US); Jianhui Shan, Pennington, NJ (US)

Correspondence Address: SANGYA JAIN;CLARIANT CORPORATION, 70 MEISTER AVENUE, SOMERVILLE, NJ, 08876, US

(21) Appl. No.: 10/941,221

(22) Filed: Sep. 15, 2004

(51) Int. Cl. G03C 5/00

(52) U.S. Cl. 430/311

(57) ABSTRACT

The present invention relates to a coating solution comprising a polymer obtained by reacting a glycoluril compound with a reactive compound containing hydroxy groups and/or acid groups, and further where the polymer is soluble in an organic solvent. The invention also relates to a process for imaging a photoresist coated over such a coating composition and to a polymer for the coating composition.

### FIELD OF INVENTION

The present invention relates to novel coating compositions and their use in image processing by forming a thin layer of the novel coating composition between a reflective substrate and a photoresist coating. Such compositions are particularly useful in the fabrication of semiconductor devices by photolithographic techniques. The invention further relates to a polymer for the coating composition.

### BACKGROUND

Photoresist compositions are used in microlithography processes for making miniaturized electronic components such as in the fabrication of computer chips and integrated circuits. Generally, in these processes, a thin coating of film of a photoresist composition is first applied to a substrate material, such as silicon wafers used for making integrated circuits. The coated substrate is then baked to evaporate any solvent in the photoresist composition and to fix the coating onto the substrate. The baked coated surface of the substrate is next subjected to an image-wise exposure to radiation.

This radiation exposure causes a chemical transformation in the exposed areas of the coated surface. Visible light, ultraviolet (UV) light, electron beam and X-ray radiant energy are radiation types commonly used today in microlithographic processes. After this image-wise exposure, the coated substrate is treated with a developer solution to dissolve and remove either the radiation-exposed or the unexposed areas of the photoresist.

The trend towards the miniaturization of semiconductor devices has led to the use of new photoresists that are sensitive to lower and lower wavelengths of radiation and has also led to the use of sophisticated multilevel systems to overcome difficulties associated with such miniaturization.

High resolution, chemically amplified, deep ultraviolet (100-300 nm) positive and negative tone photoresists are available for patterning images with less than quarter micron geometries. There are two major deep ultraviolet (uv) exposure technologies that have provided significant advancement in miniaturization, and these are lasers that emit radiation at 248 nm and 193 nm. Examples of such photoresists are given in the following patents and incorporated herein by reference, U.S. Pat. No. 4,491,628, U.S. Pat. No. 5,350,660, EP 794458 and GB 2320718. Photoresists for 248 nm have typically been based on substituted polyhydroxystyrene and its copolymers. On the other hand, photoresists for 193 nm exposure require non-aromatic polymers, since aromatics are opaque at this wavelength. Generally, alicyclic hydrocarbons are incorporated into the polymer to replace the etch resistance lost by not having aromatics present. Furthermore, at lower wavelengths the reflection from the substrate becomes increasingly detrimental to the lithographic performance of the photoresist. Therefore, at these wavelengths antireflective coatings become critical.

The use of highly absorbing antireflective coatings in photolithography is a simpler approach to diminish the problems that result from back reflection of light from highly reflective substrates. Two major disadvantages of back reflectivity are thin film interference effects and reflective notching. Thin film interference, or standing waves, result in changes in critical line width dimensions caused by variations in the total light intensity in the resist film as the thickness of the resist changes. Reflective notching becomes severe as the photoresist is patterned over substrates containing topographical features, which scatter light through the photoresist film, leading to line width variations, and in the extreme case, forming regions with complete photoresist loss.

In the past dyed photoresists have been utilized to solve these reflectivity problems. However, it is generally known that dyed resists only reduce reflectivity from the substrate but do not substantially eliminate it. In addition, dyed resists also cause reduction in the lithographic performance of the photoresist, together with possible sublimation of the dye and incompatibility of the dye in resist films.

In cases where further reduction or elimination of line width variation is required, the use of bottom antireflective coating provides the best solution for the elimination of reflectivity. The bottom antireflective coating is applied to the substrate prior to coating with the photoresist and prior to exposure. The resist is exposed imagewise and developed. The antireflective coating in the exposed area is then etched, typically in an oxygen plasma, and the resist pattern is thus transferred to the substrate. The etch rate of the antireflective film should be relatively high in comparison to the photoresist so that the antireflective film is etched without excessive loss of the resist film during the etch process. Inorganic types of antireflective coatings include such films as TiN, TiON, TiW and spin-on organic polymer in the range of 30 nm. Inorganic B.A.R.C.s require precise control of the film thickness, uniformity of film, special deposition equipment, complex adhesion promotion techniques prior to resist coating, separate dry etching pattern transfer step, and dry etching for removal.

Organic B.A.R.C.s are more preferred and have been formulated by adding dyes to a polymer coating (Proc. SPIE, Vol. 1086 (1989), p. 106). Problems of such dye blended coatings include 1) separation of the polymer and dye components during spin coating 2) dye stripping into resist solvents, and 3) thermal diffusion into the resist upon the baking process. All these effects cause degradation of photoresist properties and therefore are not the preferred composition.

Light absorbing, film forming polymers are another option. Polymeric organic antireflective coatings are known in the art as described in EP 583,205, and incorporated herein by reference. However, these polymers have been found to be ineffective when used as antireflective coatings for photoresists sensitive to 193 nm. It is believed that such antireflective polymers are very aromatic in nature and thus are too reflective, acting as a mirror rather than absorbers. Additionally, these polymers being highly aromatic, have too low a dry etch rate, relative to the new type of non-aromatic photoresists used for 193 nm exposure, and are therefore ineffective for imaging and etching. Photoresist patterns may be damaged or may not be transferred exactly to the substrate if the dry etch rate of the antireflective coating is similar to or less than the etch rate of the photoresist coated on top of the antireflective coating.

Therefore, it is necessary to have a bottom antireflective coating that functions well at exposures less than 230 nm. Such antireflective coatings need to have high etch rates in a plasma and be sufficiently absorbing to act as antireflective coatings. U.S. Pat. No. 5,935,760 describes a bottom antireflective coating based on a very specific crosslinkable polyester polymer. U.S. Pat. No. 4,255,558 discloses a self-curing polymer formed by the condensation of a glycoluril and polyhydroxyl material to give a thermosetting powder.

The novel antireflective coatings of the present invention, comprising a polymer which is soluble in an organic solvent, have been found to have good dry etching properties, which enable a good image transfer from the photoresist to the substrate, and also good absorption characteristics to prevent reflective notching and line width variations or standing waves, particularly at 193 nm. Further, the polymer of the present invention is soluble in organic solvents, thus good coatings can be formed on the substrate. The antireflective coating of the present invention has a relatively high etch rate such that the antireflective coating is removed with minimal loss in the thickness of the photoresist layer. Additionally, substantially no intermixing is present between the antireflective coating and the photoresist film. The antireflective coating solutions also have good solution stability and form particularly thin films with good coating quality, the latter being particularly advantageous for lithography. When the antireflective coating is used with a photoresist in the imaging process, clean images are obtained with good lithographic properties.

### SUMMARY

The present invention relates to a coating solution comprising a polymer obtained by reacting a glycoluril compound with a reactive compound containing hydroxy groups and/or acid groups, and further where the polymer is soluble in an organic solvent. The coating composition also contains a chromophore group either bound to the polymer or as an additive. The invention also relates to a process for imaging such a coating composition and to a polymer for the coating composition.

### DESCRIPTION OF THE INVENTION

The invention relates to a novel polymer and also to an antireflective coating solution comprising the novel polymer. The invention further relates to a process for imaging the coating solution. The novel polymer is obtained by the reaction of a glycoluril compound with a compound containing 2 or more hydroxyl groups (polyhydroxy compound or polyol), a compound containing 2 or more acid groups (polyacid compound), or a hybrid compound containing both a hydroxy and an acid group. The coating solution also contains a chromophore group which absorbs radiation and therefore can act as an antireflective coating when exposed to imaging radiation. The chromophore may be present in the novel polymer or, alternatively, the chromophore group may be present as an additive compound in the coating composition. The antireflective coating comprises the novel polymer and an organic solvent, and for this purpose, the polymer is soluble in an organic solvent so that a good quality coating may be formed. Upon heating at sufficiently high temperatures the coating is curable. A photoresist coating is then formed over the antireflective film and is further imaged.

The polymer of the present invention is formed from the condensation reaction of a reactive comonomer containing hydroxy groups and/or acid groups with a glycoluril compound. At least two reactive groups (hydroxy and/or acid) should be available in the comonomer which reacts with the gycoluril. The polymerization reaction may be catalyzed with an acid.

The glycoluril compounds are known and available commercially, and are further described in U.S. Pat. No. 4,064,191. Glycolurils are synthesized by reacting two moles of urea with one mole of glyoxal. The glycoluril can then be fully or partially methylolated with formaldehyde. A glycoluril compound containing the moiety of the general description as shown in Structure 1, is useful as a comonomer for the polymer of the present invention and becomes incorporated into the novel polymer.

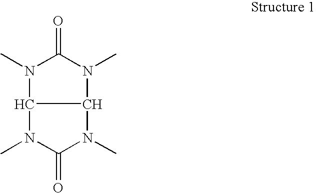

More specifically, the glycouril comonomer has the Structure 2, where R₁, R₂, R₃, and R₄ are independently H or (C₁-C₁₀) alkyl.

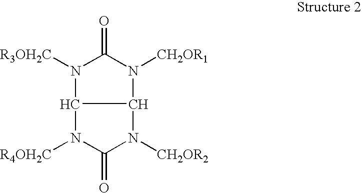

Nonlimiting examples of glycolurils are tetramethylol glycoluril, tetrabutoxymethyl glycoluril, tetramethoxymethyl glycoluril, partially methoylated glycoluril, tetramethoxymethyl glycoluril, dimethoxymethyl glycoluril, mono- and dimethylether of dimethylol glycoluril, trimethylether of tetramethylol glycoluril, tetramethylether of tetramethylol glycoluril, tetrakisethoxymethyl glycoluril, tetrakispropoxymethyl glycoluril, tetrakisbutoxymethyl glycoluril, tetrakisamyloxymethyl glycoluril, tetrakishexoxymethyl glycoluril, and the like. The glycoluril may also be in the form of an oligomer.

The polyhydroxy compound useful as the comonomer for polymerizing with the glycoluril may be a compound containing 2 or more hydroxyl groups or be able to provide 2 or more hydroxyl groups, such as diol, triol, tetrol, glycol, aromatic compounds with 2 or more hydroxyl groups, or polymers with end-capped hydroxyl groups or epoxide groups. More specifically, the polyhydroxy compound may be ethylene glycol, diethylene glycol, propylene glycol, neopentyl glycol, polyethylene glycol, styrene glycol, propylene oxide, ethylene oxide, butylene oxide, 1-phenyl-1,2-ethanediol, 2-bromo-2-nitro-1,3-propane diol, 2-methyl-2-nitro-1,3-propanediol, diethylbis(hydroxymethyl)malonate, hydroquinone, and 3,6-dithia-1,8-octanediol. Further examples of aromatic diols are Bisphenol A, 2,6-bis(hydroxymethyl)-p-cresol and 2,2′-(1,2-phenylenedioxy)-diethanol, 1,4-benzenedimethanol, 2-benzyloxy-1,3-propanediol, 3-phenoxy-1,2-propanediol, 2,2′-biphenyldimethanol, 4-hydroxybenzyl alcohol, 1,2-benzenedimethanol, 2,2′-(o-phenylenedioxy)diethanol, 1,7-dihydroxynaphthalene, 1,5-naphthalenediol, 9,10-anthracenediol, 9,10-anthracenedimethanol, 2,7,9-anthracenetriol, other naphthyl diols and other anthracyl diols.

The polyacid compound useful as the reactive comonomer for polymerizing with the glycoluril may be a compound containing 2 or more acid groups or be able to provide 2 or more acidic groups, such as diacid, triacid, tetracid, anhydride, aromatic compounds with 2 or more acid groups, aromatic anhydrides, aromatic dianhydrides, or polymers with end-capped acid or anhydride groups. More specifically, the polyacid compound may be phenylsuccinic acid, benzylmalonic acid, 3-phenylglutaric acid 1,4-phenyldiacetic acid, oxalic acid, malonic acid, succinic acid, pyromellitic dianhydride, 3,3′,4,4′-benzophenone-tetracarboxylic dianhydride, naphthalene dianhydride, 2,3,6,7-naphthalenetetracarboxylic acid dianhydride and 1,4,5,8-naphthalenetetracarboxylic acid dianhydride, and anthracene diaacid.

Hybrid compounds containing a mixture of hydroxyl and acid groups may also function as comonomers, and may be exemplified by 3-hydroxyphenylacetic acid and 2-(4-hydroxyphenoxy)propionic acid.

The reactive comonomers, in addition to containing a hydroxyl and/or acid group, may also contain a radiation absorbing chromophore, where the chrompophore absorbs radiation in the range of about 450 nm to about 140 nm. In particular for antireflective coatings useful for imaging in the deep uv (250 nm to 140 nm), aromatic moieties are known to provide the desirable absorption characteristics. These chromophores may be aromatic or heteroaromatic moieties, examples of which are substituted or unsubstituted phenyl, substituted or unsubstituted naphthyl, and substituted or unsubstituted anthracyl. Typically, anthracyl moieties are useful for 248 nm exposure, and phenyl moieties are useful for 193 nm exposure. The aromatic groups may have pendant hydroxy and/or acid groups or groups capable of providing hydroxy or acid groups (e.g. epoxide or anhydride) either attached directly to the aromatic moiety or through other groups, where these hydroxy or acid groups provide the reaction site for the polymerization process. As an example, styrene glycol or an anthracene derivative, may be polymerized with a glycoluril of Structure 2.

In another embodiment the chromophore group may be present as an additive, where the additive is a monomeric or polymeric compound. Monomers containing substituted or unsubstituted phenyl, substituted or unsubstituted naphthyl, and substituted or unsubstituted anthracyl may be used. Aromatic polymers function well as chromophoric additives. Example of chromphoric polymers are ones polymerized with at least one or more of the following comonomers: styrene or its derivatives, phenols or its derivatives and an aldehyde, and (meth)acrylates with pendant phenyl, naphthyl or anthracyl groups. More specifically the monomers can be 4-hydroxystyrene, styrene glycol, cresol and formaldehyde, 1-phenyl-1,2-ethanediol, bisphenol A, 2,6-bis(hydroxymethyl)-p-cresol, ethylene glycol phenyl ether acrylate, 2-(4-benzoyl-3-hydroxyphenoxy)ethyl acrylate, 2-hydroxy-3-phenoxypropyl acrylate, benzyl methacrylate, 2,2′-(1,2-phenylenedioxy)-diethanol, 1,4-benzenedimethanol, naphthyl diols, anthracyl diols, phenylsuccinic acid, benzylmalonic acid, 3-phenylglutaric acid, 1,4-phenyldiacetic acid, pyromellitic dianhydride, 3,3′,4,4′-benzophenone-tetracarboxylic dianhydride, naphthalene dianhydride, 2,3,6,7-naphthalenetetracarboxylic acid dianhydride, 1,4,5,8-naphthalenetetracarboxylic acid dianhydride, 9-anthracene methacrylate, and anthracene diaacid.

In certain instances it is important to control the etch resistance and absorptivity of the antireflective coating. In order to provide the desired etch rate of the antireflective coating, especially for imaging below 200 nm, the degree of aromaticity in the polymer may be varied. For high etch rates the aromatic component in the polymer backbone is reduced. It is generally known to those of ordinary skill in the art that aromatics decrease the etch rate. For low etch rates and/or high absorptivity, highly aromatic polymers are desirable. However, in some embodiments, particularly for imaging at wavelengths below 200 nm, optimum performance may be obtained by controlling the etch rate and the absorptivity by using an appropriate mixture of an aliphatic and an aromatic monomer. The aromatic functionality may also be incorporated at other functional points within the polymer. In cases where the absorbing aromatic component is an additive, using the appropriate concentration of that component in the coating solution may give the optimum properties.

The polymer of the present invention is synthesized by polymerizing the comonomers described previously. Typically, the desired glycoluril or mixtures of glycolurils is reacted with the polyol, polyacid and/or hybrid compounds in the presence of a suitable acid. The polymer may be a linear polymer made with a glycoluril with 2 linking sites that are reacted or a network polymer where the glycoluril has more than 2 reactive sites connected to the polymer. Other comonomers may also be added to the reaction mixture and polymerized to give the polymer of the present invention. Strong acids, such as sulfonic acids are preferred as catalyst for the polymerization reaction. A suitable reaction temperature and time is selected to give a polymer with the desired physical properties, such as molecular weight. The weight average molecular weight (Mw) of the polymer is in the range of 3,000 to 50,000, preferably 4,100 to 40,000, and more preferably 4,500 to 40,000, and even more preferably 5,000 to 35,000. When the weight average molecular weight is low, such as below 3000, then good film forming properties are not obtained for the antireflective coating and when the weight average molecular weight is too high, then properties such as solubility, storage stability and the like may be compromised.

The antireflective coating composition comprises a polymer and an organic solvent. Optionally an acid or/and an acid generator may be added to the composition. Additionally, a crosslinking agent may be added but is not completely essential to the performance of the antireflective coating. The polymer of the present invention is itself crosslinkable, but for certain embodiments, additional monomeric or polymeric crosslinkers may be added. These crosslinkers have reactive sites (e.g. hydroxy, carboxy, etc) which can bind with the polymer of the invention.

A variety of crosslinking agents can be used in the composition of the present invention. Any suitable crosslinking agents that can crosslink the polymer in the presence of an acid may be used. Examples, without limitation, of such crosslinking agents are resins containing melamines, methylols, glycoluril, benzoguanamine, urea, hydroxy alkyl amides, epoxy and epoxy amine resins, blocked isocyanates, and divinyl monomers. Monomeric melamines like hexamethoxymethyl melamine; glycolurils like tetrakis(methoxymethyl)glycoluril; and aromatic methylols, like 2,6 bishydroxymethyl p-cresol are preferred.

The acid generator of the present invention, preferably a thermal acid generator is a compound which, when heated to temperatures greater than 90° C. and less than 250° C., generates an acid. The acid enables the polymer to be crosslinked. The antireflective film after heat treatment becomes insoluble in the solvents used for coating photoresists, and furthermore, is also insoluble in the alkaline developer used to image the photoresist. Preferably, the thermal acid generator is activated at 90° C. and more preferably at above 120° C., and even more preferably at above 150° C. The antireflective film is heated for a sufficient length of time to crosslink the coating. Examples of thermal acid generators are nitrobenzyl tosylates, such as 2-nitrobenzyl tosylate, 2,4-dinitrobenzyl tosylate, 2,6-dinitrobenzyl tosylate, 4-nitrobenzyl tosylate; benzenesulfonates such as 2-trifluoromethyl-6-nitrobenzyl 4-chlorobenzenesulfonate, 2-trifluoromethyl-6-nitrobenzyl 4-nitro benzenesulfonate; phenolic sulfonate esters such as phenyl, 4-methoxybenzenesulfonate; alkyl ammonium salts of organic acids, such as triethylammonium salt of 10-camphorsulfonic acid.

Thermal acid generators are preferred over free acids, although free acids may also be used, in the novel antireflective composition, since it is possible that over time the shelf stability of the antireflective solution will be affected by the presence of the acid, if the polymer were to crosslink in solution. Thermal acid generators are only activated when the antireflective film is heated on the substrate. Additionally, mixtures of thermal acids and free acids may be used. Although thermal acid generators are preferred for crosslinking the polymer efficiently, an antireflective coating composition comprising the polymer and optionally a crosslinking agent may also be used, where heating crosslinks the polymer. Examples of a free acid are, without limitation, strong acids, such as sulfonic acids. Sulfonic acids such as toluene sulfonic acid, triflic acid or mixtures of these are preferred.

The novel composition may further contain a photoacid generator, examples of which without limitation, are onium salts, sulfonate compounds, nitrobenzyl esters, triazines, etc. The preferred photoacid generators are onium salts and sulfonate esters of hydoxyimides, specifically diphenyl iodnium salts, triphenyl sulfonium salts, dialkyl iodonium salts, triakylsulfonium salts, and mixtures thereof.

The amount of the polymer in the present composition can vary from about 95 weight % to about 50 weight %, preferably about 85 weight % to about 70 weight % and more preferably about 80 weight % to about 70 weight %, relative to the solid portion of the composition. The amount of optional crosslinker in the present composition can vary from 5 weight % to about 50 weight %, preferably 15 weight % to about 30 weight % relative to the solid portion of the composition. The amount of the optional acid or acid generator in the present composition can vary from 0.1 weight % to about 5 weight %, preferably 0.5 weight % to about 3 weight % and more preferably 1 weight % to about 2 weight %, relative to the solid portion of the composition.

Typical solvents, used as mixtures or alone, that can be used for the present composition, without limitation, are propylene glycol monomethyl ether acetate (PGMEA), propylene gycol monomethyl ether (PGME), and ethyl lactate (EL), 2-heptanone, cyclopentanone, cyclohexanone, and gamma butyrolactone, but PGME, PGMEA and EL or mixtures thereof are preferred. Solvents with a lower degree of toxicity, good coating and solubility properties are generally preferred.

The antireflective coating composition comprises the polymer, the acid generator and a suitable solvent or mixtures of solvents. Other components may be added to enhance the performance of the coating, e.g. monomeric dyes, polymeric dyes, monomeric or polymeric crosslinkers, lower alcohols, surface leveling agents, adhesion promoters, antifoaming agents, etc. Other secondary polymers, which can function as dyes and/or crosslinkers may be used, such as, novolaks, polyhydroxystyrene, polymethacrylate, polyarylates, poly(hydroxystyrene-methylmethacrylate), homopolymers and/or copolymers obtained by polymerization of at least one of the following monomers: styrene, hydroxystyrene, hydroxyethyl (methyl)acrylate, hydroxypropyl (methyl)acrylate, methyl (methyl)acrylate, ethyl (methyl)acrylate, (methyl)acrylic acid, polymers described in US patents U.S. Pat. No. 6,465,148, U.S. Pat. No. 5,733,714, U.S. Pat. No. 6,737,492, U.S. Pat. No. 6,187,506 and U.S. Pat. No. 5,981,145. The optional secondary polymer may be up to 95 weight % of the total solids of the composition, preferably 5 weight % to 60 weight %; but ultimately, the amount of the secondary polymers added depends on the lithographic properties desired.

The optical characteristics of the antireflective coating are optimized for the exposure wavelength and other desired lithographic characteristics. As an example the absorption parameter (k) of the novel composition for 193 nm exposure ranges from about 0.1 to about 1.0, preferably from about 0.2 to about 0.75, more preferably from about 0.25 to about 0.65 as measured using ellipsometry. The value of the refractive index (n) ranges from about 1.25 to about 2.0, preferably from about 1.3 to about 2.0, and more preferably from about 1.5 to about 2.0. Since the antireflective film is coated on top of the substrate and is further subjected to dry etching, it is envisioned that the film is of sufficiently low metal ion level and of sufficient purity that the properties of the semiconductor device are not adversely affected. Treatments such as passing a solution of the polymer through an ion exchange column, filtration, and extraction processes can be used to reduce the concentration of metal ions and to reduce particles.

The antireflective coating composition is coated on the substrate using techniques well known to those skilled in the art, such as dipping, spin coating or spraying. The film thickness of the antireflective coating ranges from about 20 nm to about 200 nm. The optimum film thickness is determined, as is well known in the art, to be where no standing waves are observed in the photoresist. It has been unexpectedly found that for this novel composition very thin coatings can be used due to the excellent absorption and refractive index properties of the film. The coating is further heated on a hot plate or convection oven for a sufficient length of time to remove any residual solvent and induce crosslinking, and thus insolubilizing the antireflective coating to prevent intermixing between the antireflective coating and the photoresist layer.

Photoresists can be any of the types used in the semiconductor industry, provided the photoactive compound in the photoresist and the antireflective coating absorb at the exposure wavelength used for the imaging process.

There are two types of photoresist compositions, negative-working and positive-working. When negative-working photoresist compositions are exposed image-wise to radiation, the areas of the resist composition exposed to the radiation become less soluble to a developer solution (e.g. a cross-linking reaction occurs) while the unexposed areas of the photoresist coating remain relatively soluble to such a solution. Thus, treatment of an exposed negative-working resist with a developer causes removal of the non-exposed areas of the photoresist coating and the creation of a negative image in the coating, thereby uncovering a desired portion of the underlying substrate surface on which the photoresist composition was deposited.

On the other hand, when positive-working photoresist compositions are exposed image-wise to radiation, those areas of the photoresist composition exposed to the radiation become more soluble to the developer solution (e.g. a rearrangement reaction occurs) while those areas not exposed remain relatively insoluble to the developer solution. Thus, treatment of an exposed positive-working photoresist with the developer causes removal of the exposed areas of the coating and the creation of a positive image in the photoresist coating. Again, a desired portion of the underlying surface is uncovered.

Positive working photoresist compositions are currently favored over negative working resists because the former generally have better resolution capabilities and pattern transfer characteristics. Photoresist resolution is defined as the smallest feature which the resist composition can transfer from the photomask to the substrate with a high degree of image edge acuity after exposure and development. In many manufacturing applications today, resist resolution on the order of less than one micron are necessary. In addition, it is almost always desirable that the developed photoresist wall profiles be near vertical relative to the substrate. Such demarcations between developed and undeveloped areas of the resist coating translate into accurate pattern transfer of the mask image onto the substrate. This becomes even more critical as the push toward miniaturization reduces the critical dimensions on the devices.

Any photoresists sensitive to ultraviolet radiation may be used. Photoresists based on novolac resins and diazonaphthoquinone diazide are suitable for radiation wavelengths between 450 nm and 300 nm. Such photoresists are described in U.S. Pat. No. 5,162,510 and U.S. Pat. No. 5,371,169. Photoresists sensitive at short wavelengths, between about 180 nm and about 300 nm can also be used in the present invention. These photoresists normally comprise polyhydroxystyrene or substituted polyhydroxystyrene derivatives, a photoactive compound, and optionally a solubility inhibitor. The following references exemplify the types of photoresists used and are incorporated herein by reference, U.S. Pat. No. 4,491,628, U.S. Pat. No. 5,069,997 and U.S. Pat. No. 5,350,660. Particularly preferred for 193 nm and 157 nm exposure are photoresists comprising non-aromatic polymers, a photoacid generator, optionally a solubility inhibitor, and solvent. Photoresists sensitive at 193 nm that are known in the prior art are described in the following references and incorporated herein, EP 794458, WO 97/33198 and U.S. Pat. No. 5,585,219, although any photoresist sensitive at 193 nm may be used on top of the antireflective composition of this invention. Fluorinated polymers are known for being transparent at 193 nm and 157 nm. Such polymers when used in a photoresist are disclosed in EP 789,278, WO 00/67072 and WO 00/17712. WO 00/67072 specifically discloses nonaromatic, alicyclic polymers with pendant fluorinated groups.

The process of the instant invention further comprises coating a substrate with the novel antireflective coating and heating on a hotplate or convection oven at a sufficiently high temperature for sufficient length of time to remove the coating solvent, and crosslink the polymer to a sufficient extent so that the coating is not soluble in the coating solution of the photoresist or in the aqueous alkaline developer. An edge bead remover may be applied to clean the edges of the substrate using processes well known in the art. The preferred range of temperature is from about 90° C. to about 250° C. If the temperature is below 90° C. then insufficient loss of solvent or insufficient amount of crosslinking takes place, and at temperatures above 250° C. the composition may become chemically unstable. A film of photoresist is then coated on top of the antireflective coating and baked to substantially remove the photoresist solvent. The photoresist is imagewise exposed and developed in an aqueous developer to remove the treated photoresist. The developer is preferably an aqueous alkaline solution comprising, for example, tetramethyl ammonium hydroxide. An optional heating step can be incorporated into the process prior to development and after exposure. The developer may additionally contain additives to enhance the imaging process, such as surfactants, polymers, etc.

The process of coating and imaging photoresists is well known to those skilled in the art and is optimized for the specific type of resist used. The patterned substrate can then be dry etched with an etching gas or mixture of gases, in a suitable etch chamber to remove the exposed portions of the antireflective film, with the remaining photoresist acting as an etch mask. Various gases are known in the art for etching organic antireflective coatings, such as O₂, Cl₂, F₂ and CF₄.

An intermediate layer may be placed between the antireflective coating and the photoresist to prevent intermixing, and is envisioned as lying within the scope of this invention. The intermediate layer is an inert polymer cast from a solvent, where examples of the polymer are polysulfones and polyimides.

Each of the documents referred to above are incorporated herein by reference in its entirety, for all purposes. The following specific examples will provide detailed illustrations of the methods of producing and utilizing compositions of the present invention. These examples are not intended, however, to limit or restrict the scope of the invention in any way and should not be construed as providing conditions, parameters or values which must be utilized exclusively in order to practice the present invention.

### EXAMPLES

The refractive index (n) and the absorption (k) values of the antireflective coating in the Examples below were measured on a J. A. Woollam VASE32 ellipsometer.

The molecular weight of the polymers was measured on a Gel Permeation Chromatograph.

### Synthesis Example 1

600 grams of tetramethoxymethyl glycoluril, 96 grams of styrene glycol and 1200 grams of propyleneglycolmonomethyl ether acetate (PGMEA) were charged into a 2 liter(l) jacketed flask with a thermometer, mechanical stirrer and a cold water condenser and heated to 85° C. A catalytical amount of para-toluenesulfonic acid monohydrate was added, and the reaction was maintained at this temperature for 5 hrs. The reaction solution was then cooled to room temperature and filtered. The filtrate was slowly poured into distilled water to precipitate the polymer. The polymer was filtered, washed thoroughly with water and dried in a vacuum oven (250 grams of the polymer were obtained). The polymer obtained had a weight average molecular weight of about 17,345 g/mol and a polydispersity of 2.7. H¹NMR showed that the polymer was a condensation product of the two starting materials. A broad peak centered at 7.3 ppm was indicative of the benzene moiety present in the polymer and the broad peak centered at 3.3 ppm was contributed by unreacted methoxy groups (CH₃O) on tetramethoxymethyl glycoluril.

### Synthesis Example 2

260 grams of tetramethoxymethyl glycoluril, 41.6 grams of neopentyl glycol and 520 grams of PGMEA were charged into a 21 jacketed flask with a thermometer, mechanical stirrer and a cold water condenser and heated to 85° C. A catalytical amount of para-toluenesulfonic acid monohydrate was added, and the reaction was maintained at this temperature for 5 hrs. The reaction solution was then cooled to room temperature and filtered. The filtrate was slowly poured into distilled water while stirring in order to precipitate the polymer. The polymer was filtered, washed thoroughly with water and dried in a vacuum oven (250 grams of the polymer were obtained). The polymer obtained had a weight average molecular weight of about 18,300 g/mol and a polydispersity of 2.8. A broad peak centered at 0.9 ppm assigned to methyl groups of neopentyl glycol and the broad peak centered at 3.3 ppm characteristic of unreacted methoxy groups (CH₃O) on tetramethoxymethyl glycoluril showed that the polymer obtained was a condensation product of the two starting materials.

### Synthesis Example 3

50 grams of tetramethoxymethyl glycoluril, 23.9 grams of styrene glycol, and 35 grams of 2-methyl-2-nitro-propanediol were charged into a 500 ml jacketed flask with a thermometer and mechanical stirrer. The reaction mixture was heated to 100° C. and a clear solution was obtained. A catalytical amount of para-toluenesulfonic acid monohydrate was added, and the reaction was maintained for 60 minutes. Then 60 grams of PGMEA was added and the reaction was maintained for another 2 hrs. The reaction solution was then cooled to room temperature and filtered. The filtrate was slowly poured into ether while stirring to precipitate the polymer. The polymer was filtered, washed thoroughly with ether and dried in a vacuum oven (33 grams of the polymer were obtained). The polymer obtained had a weight average molecular weight of about 6,305 g/mol and a polydispersity of 2.6.

### Synthesis Example 4

50 grams of tetramethoxymethyl glycoluril and 20 grams of styrene glycol were charged into a 500 ml jacketed flask with a thermometer and a mechanical stirrer. The reaction mixture was heated to 100° C. A catalytical amount of para-toluenesulfonic acid monohydrate was added, the reaction was maintained at this temperature for 60 min. Then 50 grams of PGMEA was added and the reaction was maintained for another 3 hrs. The reaction solution was then cooled to room temperature and filtered. The filtrate was slowly poured into distilled water while stirring to precipitate the polymer. The polymer was filtered, washed thoroughly with water and dried in a vacuum oven (40 grams of the polymer were obtained). The polymer obtained had a weight average molecular weight of about 16,327 g/mol and a polydispersity of 6.7. H¹NMR showed that the polymer was a condensation product of the two starting materials. A broad peak centered at 7.3 ppm was indicative of benzene moiety in the polymer and the broad peak centered at 3.3 ppm was contributed by unreacted methyl groups on tetramethoxymethyl glycoluril.

### Synthesis Example 5

50 grams of tetramethoxymethyl glycoluril, 20 grams of styrene glycol, and 20 grams of polyethylene glycol (number average molecular weight, Mn, of 1000 g/mol) were charged into a 500 ml jacketed flask with a thermometer and a mechanical stirrer. The reaction mixture was heated to 98° C. A catalytical amount of para-toluenesulfonic acid monohydrate was added, the reaction was maintained at this temperature for 60 min. Then 60 grams of propyleneglycolmonomethyl ether acetate (PGMEA) was added and the reaction was maintained for another three and half hours. The reaction solution was then cooled to room temperature and filtered. The filtrate was slowly poured into ether while stirring to precipitate the polymer. The polymer was filtered, washed thoroughly with ether and dried in a vacuum oven (50 grams of the polymer were obtained). The polymer obtained had a weight average molecular weight of about 4,195 g/mol and a polydispersity of 2.04.

### Synthesis Example 6

50 grams of tetramethoxymethyl glycoluril, 20 grams of styrene glycol, and 23 grams of dimethyltartate were charged into a 500 mL jacketed flask with a thermometer and a mechanical stirrer. The reaction mixture was heated to 96° C. After catalytical amount of para-toluenesulfonic acid monohydrate was added, the reaction was maintained at this temperature for 1 hr. Then 50 grams of PGMEA was added, the reaction was maintained for another 1 hr. The reaction solution was then cooled to room temperature and filtered. The filtrate was slowly poured into either under stirring to precipitate the polymer. The polymer was filtered, washed thoroughly with ether and dried in a vacuum oven (8 grams obtained). The polymer obtained had a weight average molecular weight of about 4,137 g/mol and a polydispersity of 2.31.

### Lithographic Evaluation Example 1

An antireflective coating composition was prepared by dissolving 2.4 g of the polymer prepared in Example 1 and 0.048 g of triethylammonium salt of 10-camphorsulfonic acid in 47.6 g ethyl lactate. The solution was filtered through 0.2 μm filter.

The performance of the anti-reflective coating formulation was evaluated using AZ® EXP AX1120P photoresist (available from AZ®) Electronic Materials, Clariant Corporation, Somerville, N.J.). An antireflective film from the above solution was coated on a silicon wafer and baked at 200° C. for 60 seconds. The antireflective film was found to have (n) value of 1.9 and (k) value of 0.34. Using AZ® EXP AX1120P photoresist a 330 nm film was coated and baked at 115° C. for 60 seconds. The wafer was then imagewise exposed using a 193 nm exposure tool. The exposed wafer was baked at 110° C. for 60 seconds and developed using a 2.38 wt % aqueous solution of tetramethyl ammonium hydroxide for 60 seconds. The line and space patterns when observed under scanning electron microscope showed no standing waves, thus indicating the efficacy of the bottom anti-reflective coating.

### Lithographic Evaluation Example 2

An antireflective coating composition was prepared by dissolving 1.2 g of the polymer prepared in Example 1, 1.2 grams of poly(hydroxystyrene-methylmethacrylate) copolymer (Mw of about 16,000 g/mol), 0.048 g triethylammonium salt of 10-camphorsulfonic acid in 47.6 g ethyl lactate. The solution was filtered through 0.2 μm filter.

The performance of the anti-reflective coating formulation was evaluated using AZ® EXP AX1120P photoresist (available from AZ® (Electronic Materials, Clariant Corporation, Somerville, N.J.). An antireflective film from the above solution was coated on a silicon wafer and baked at 200° C. for 60 seconds. The antireflective film was found to have (n) value of 1.74 and (k) value of 0.36. Using AZ® EXP AX1120P photoresist a 330 nm film was coated and baked at 115° C. for 60 seconds. The wafer was then imagewise exposed using a 193 nm exposure tool. The exposed wafer was baked at 110° C. for 60 seconds and developed using a 2.38 wt % aqueous solution of tetramethyl ammonium hydroxide for 60 seconds. The line and space patterns when observed under scanning electron microscope showed no standing waves, thus indicating the efficacy of the bottom anti-reflective coating.

### Lithographic Evaluation Example 3

An antireflective coating composition was prepared by dissolving 0.8 grams of poly(hydroxystyrene-methylmethacrylate) copolymer, 0.2 grams of polymer prepared in Example 2, 0.048 g triethylammonium salt of 10-camphorsulfonic acid in 47.6 g ethyl lactate. The solution was filtered through 0.2 μm filter.

The performance of the anti-reflective coating formulation was evaluated using AZ® EXP AX1120P photoresist (available from AZ® Electronic Materials, Clariant Corporation, Somerville, N.J.). An antireflective film from the above solution was coated on a silicon wafer and baked at 200° C. for 60 seconds. The antireflective film was found to have (n) value of 1.61 and (k) value of 0.49. Using AZ® EXP AX1120P photoresist a 330 nm film was coated and baked at 115° C. for 60 seconds. The wafer was then imagewise exposed using a 193 nm exposure tool. The exposed wafer was baked at 110° C. for 60 seconds and developed using a 2.38 wt % aqueous solution of tetramethyl ammonium hydroxide for 60 seconds. The line and space patterns when observed under scanning electron microscope showed no standing waves, thus indicating the efficacy of the bottom anti-reflective coating.

1. A coating solution comprising a polymer obtained by reacting a glycoluril compound with a reactive compound containing hydroxy groups and/or acid groups, and further where the polymer is soluble in an organic solvent.

2. The coating composition according to claim 1, where the reactive compound contains 2 or more hydroxy or acid groups.

3. The coating composition according to claim 1, where the reactive compound contains a hydroxy group and an acid group.

4. The coating according to claim 1, where the polymer further comprises a chromophore group.

5. The coating solution according to claim 1 further comprising an organic solvent composition.

6. The coating solution according to claim 1, where the polymer comprises at least one unit of the structure

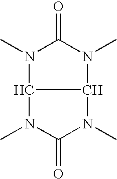

7. The coating solution according to claim 4, where the chromophore group absorbs radiation in the range 450 nm to 140 nm.

8. The coating solution according to claim 1, where the reactive compound is selected from ethylene glycol, diethylene glycol, propylene glycol, neopentyl glycol, polyethylene glycol, styrene glycol, polypropylene oxide, polyethylene oxide, butylenes oxide, 1-phenyl-1,2-ethanediol, 2-bromo-2-nitro-1,3-propane diol, 2-methyl-2-nitro-1,3-propanediol, diethylbis(hydroxymethyl)malonate, hydroquinone, and 3,6-dithia-1,8-octanediol, Bisphenol A, 2,6-bis(hydroxymethyl)-p-cresol and 2,2′-(1,2-phenylenedioxy)-diethanol, 1,4-benzenedimethanol, phenylsuccinic acid, benzylmalonic acid, 3-phenylglutaric acid 1,4-phenyldiacetic acid, oxalic acid, malonic acid, succinic acid, pyromellitic dianhydride, 3,3′,4,4′-benzophenone-tetracarboxylic dianhydride, naphthalene dianhydride, 2,3,6,7-naphthalenetetracarboxylic acid dianhydride, 1,4,5,8-naphthalenetetracarboxylic acid dianhydride, 3-hydroxyphenylacetic acid, and 2-(4-hydroxyphenoxy)propionic acid.

9. The coating solution according to claim 1, where the glycoluril compound is selected from tetramethylol glycoluril, tetrabutoxymethyl glycoluril, tetramethoxymethyl glycoluril, partially methoylated glycoluril, tetramethoxymethyl glycoluril, dimethoxymethyl glycoluril, mono- and dimethylether of dimethylol glycoluril, trimethylether of tetramethylol glycoluril, tetramethylether of tetramethylol glycoluril, tetrakisethoxymethyl glycoluril, tetrakispropoxymethyl glycoluril, tetrakisbutoxymethyl glycoluril, tetrakisamyloxymethyl glycoluril, and tetrakishexoxymethyl glycoluril.

10. The coating solution according to claim 4, where the chromophore group is selected from an aromatic group and hetroaromatic group.

11. The coating solution according to claim 10, where the chromophore group is selected from a phenyl group, a substituted phenyl group, a naphthyl group, a substituted naphthyl group, an anthracyl group and a substituted anthracyl group.

12. The coating solution according to claim 1, further comprising an acid or an acid generator.

13. The coating solution according to claim 12, where the acid generator is a thermal or photoacid generator.

14. The coating solution according to claim 1, further comprising a secondary polymer.

15. The coating solution according to claim 14, where the secondary polymer has a chromophore group.

16. The coating solution according to claim 14, where the secondary polymer has a crosslinking group.

17. A process for forming an image comprising,
a) coating and baking a substrate with the coating composition of claim 1;
b) coating and baking a photoresist film on top of the antireflective coating;
c) imagewise exposing the photoresist;
d) developing an image in the photoresist;
e) optionally, baking the substrate after the exposing step.

18. The process of claim 17, where the photoresist is imagewise exposed at wavelengths between 140 nm to 450 nm.

19. The process of claim 17, where the photoresist comprises a polymer and a photoactive compound.

20. The process of claim 17, where the antireflective coating is baked at temperatures greater than 90° C.

21. A polymer obtained by reacting a glycoluril compound with a reactive compound containing hydroxy groups and/or acid groups, and further where the polymer is soluble in an organic solvent.
